(19) United States
(12) Patent Application Publication
(10) Pub. No.: US 2007/0199812 A1
(43) Pub. Date: Aug. 30, 2007

(54) Electronic Key

(75) Inventor: Gerhard Seidel, Denkendorf (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/572,096

(22) PCT Filed: Aug. 11, 2004
(86) PCT No.: PCT/EP04/08977

§ 371 Date: Jan. 5, 2007

(30) Foreign Application Priority Data
Sep. 16, 2003 (DE) 103 42 663.9

(51) Int. Cl. H01H 13/00

(52) U.S. Cl. 200/329

(57) ABSTRACT

An electronic key for a locking system of a motor vehicle including a plastic housing part which has at least two actuating elements on the same side for at least one electrical switch. The housing part has a field which cannot be actuated, is at least slightly raised or lowered in relation to the actuation elements and forms a tactile separation between the at least tow actuation elements.

### BACKGROUND AND SUMMARY OF THE INVENTION

The invention relates to an electronic key for a locking system of a motor vehicle.

Modern locking systems for motor vehicles are often provided with an electronic key, for example a radio key, in order to increase the convenience for the user. After the electronic key has been appropriately actuated by the user, a code, for example a radio code, is exchanged between the key and the locking system so that after this code has been positively evaluated the doors or the lid of the trunk of the motor vehicle can be unlocked or locked remotely and other functions, for example locking of the side windows or of the sunroof, can be triggered.

German Patent Document DE 199 15 969 A1 discloses such a key with a plastic housing part. The housing part has an actuation element for an electronic switch, the actuation element being embodied in the manner of a button which can be deformed elastically for the purpose of actuation and extends, if appropriate, essentially in the surface of the housing part. The actuation element is arranged on a rigid support element which is essentially nondeformable when the actuation element is actuated. Both the actuation element and the support element are prefabricated as semifinished parts. The two semifinished parts are encapsulated by injection molding along at least part of their edge with the plastic for the housing part during the manufacture of the housing part by injection molding. As a result, the actuation element together with the support element is embedded in the housing part in such a way that the actuation element itself serves to seal the opening in the housing part and nevertheless can be moved in order to actuate the switch.

The present invention is concerned with the problem of specifying an improved embodiment for an electronic key of the type discussed above, in which the handling of the electronic key is simplified.

The invention is based on the concept of providing, in an electronic key for a locking system of a motor vehicle which has at least two actuation elements on the same side of a housing, respectively for one electrical switch, a field which cannot be actuated, is at least slightly raised or lowered in relation to the actuation elements and produces a tactile separation, and thus better means of orientation, between the at least two actuation elements.

In each case electrical switches which, when actuated, bring about specific functions such as, for example, opening or closing of the locking system of the vehicle and remote unlocking of the lid of the trunk are respectively assigned to the actuation elements.

In particular at night, the different actuation elements which can be embodied one right next to the other in the manner of a button which can be deformed elastically for the purpose of actuation and extends essentially in the surface of the housing part can be differentiated only with difficulty. As a result, the field which cannot be actuated, is slightly raised or lowered and is arranged between the individual actuation elements, the actuation elements can easily be differentiated from one another by touch, and operated reliably. At the same time, the orientation in relation to the position of the individual actuation elements on a surface of the electronic key is significantly improved. The field which protrudes slightly in relation to the actuation elements and thus in relation to the surface of the electronic key also permits the actuation elements to be located more easily since they are arranged on the same side as the raised or lowered field, thus additionally simplifying the handling of the electronic key.

It is particularly important here that the field itself cannot be actuated, that is to say in particular is not a pushbutton key so that the user can very easily feel the field and orientate himself.

According to one advantageous embodiment of the solution according to the invention, the field may bear an emblem or be embodied as one. Such an emblem, for example a trade mark or a logo, gives the surface of the field good grip and thus makes it more comfortable to operate. At the same time, providing an emblem on the field which cannot be actuated, or forming said field as an emblem, provides an additional differentiating feature in relation to other electronic keys. Furthermore, the emblem may be embodied as a design element and thus improve the visual appearance of the electronic key.

The emblem can expediently be highlighted visually with respect to the housing part. The visual highlighting, for example in the form of a chrome plated logo such as, for example, a chrome plated Mercedes star, permits the electronic key to be assigned easily to a specific type of vehicle or a specific make of vehicle. In addition to design advantages, this feature also facilitates orientation in relation to the various actuation elements on the electronic key.

According to one advantageous development of the invention, three actuation elements may be provided, the field which cannot be actuated being arranged centrally in relation to the three actuation elements. As the number of actuation elements provided on the electronic key increases, the greater the difficulty of orientation in relation to said elements, and the more important is a fixed orientation point, which is provided by the field arranged centrally between the actuation elements. It is generally conceivable for different numbers of actuation elements to be provided on the electronic key depending on the equipment level of the vehicle, in which case the field, which cannot be actuated and is slightly raised or lowered, is always arranged in such a way that it permits an easy tactile separation between the individual actuation elements.

Further important features and advantages of the invention emerge, from the drawings and from the associated description of the figures with reference to the drawings.

Of course, the features which are specified above and are to be explained below can be used not only in the respectively specified combination but also in other combinations or alone without departing from the scope of the present invention.

Preferred exemplary embodiments of the invention are illustrated in the drawings and will be explained in more detail in the following descriptions, in which identical reference symbols refer to identical or similar or functionally identical components.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an electronic key according to the invention in a plan view, and

FIG. 2 shows a side view of the electronic key.

### DETAILED DESCRIPTION OF THE DRAWINGS

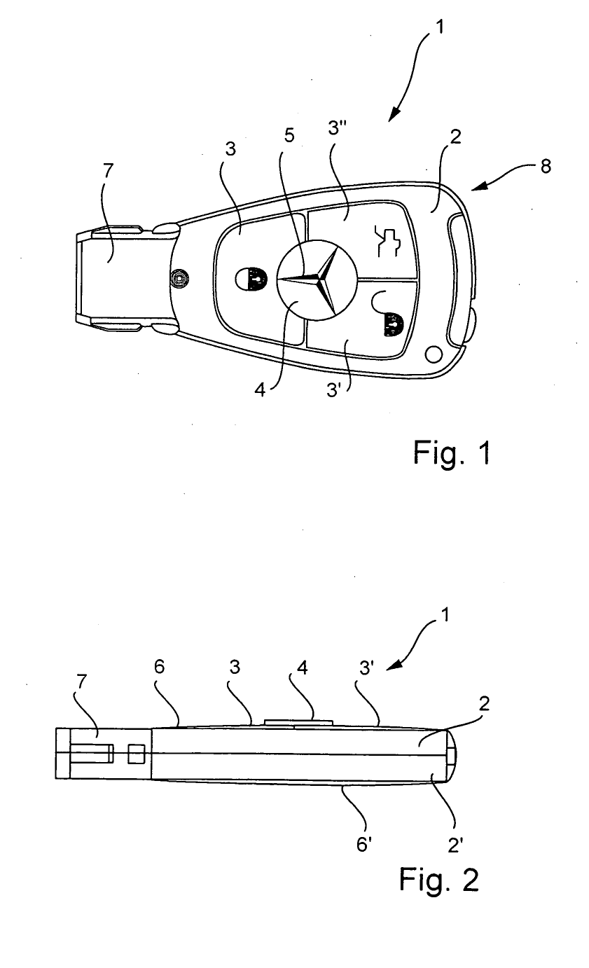

FIG. 1 shows an electronic key 1 for a locking system on a motor vehicle. The electronic key 1 has a housing 8 on which a plurality of actuating elements 3, 3′ and 3″ for remote-controlled triggering of functions of the locking system are arranged. Manually actuating the first actuation element 3 causes the lock system of the motor vehicle to be placed in a closed setting, while actuation of the second actuating element 3′ causes the abovementioned locking system to be opened. The third actuating element 3″ is designed to open a lid of a trunk remotely. In this context, the symbols corresponding to these functions are provided on the actuating elements 3, 3′ and 3″.

The housing 8 has an ergonomically favorable shape which can be handled in a particularly ergonomic way by the user. Furthermore, the housing 8 is favorably manufactured from two housing parts 2 and 2′ which are formed from a hard, impact resistant plastic. At one end of the housing 8, the electronic key 1 has a front part 7 with which it can be plugged into a vehicle lock, for example into an ignition lock (not illustrated).

FIG. 1 shows by way of example an embodiment variant with a total of three actuating elements 3, 3′ and 3″. However, other embodiment variants with fewer or more actuating elements are generally also conceivable. The actuating elements 3, 3′ and 3″ are embodied in the manner of a button which can be deformed elastically for the purpose of actuation and extends essentially in a surface 6 of the housing part 2. The respective actuating element 3, 3′ or 3″ is actuated by pressing it. The actuating elements 3, 3′ and 3″ are all arranged on the same side of the housing 8.

In order to facilitate orientation between the individual actuating elements 3, 3′ and 3″, the electronic key 1 has a field 4 which cannot be actuated, is at least slightly raised, i.e. protruding, or lowered in relation to the actuating elements 3, 3′ and 3″, and forms a tactile separation between the individual actuating elements 3, 3′ and 3″ (cf. also FIG. 2). It is essential here that the field 4 be located on the same side of the housing 8 as the actuating elements 3, 3′, 3″. In contrast to this, the other side of the housing 8 is preferably haptically smooth, which permits unambiguous orientation for the user.

According to FIG. 1, the slightly raised or lowered field 4 is arranged essentially centrally between the actuating elements 3, 3′ and 3″ here, but it is also conceivable to arrange it in some other way, in particular if fewer or more actuating elements are arranged.

From FIG. 2 it is clear that the field 4 is arranged only on one side of the electronic key, here the surface 6, while the other housing part 2′ has a slightly curved but noncontoured surface 6′. This facilitates easy handling of the electronic key 1, in particular at twilight or in poor visibility conditions, since the slightly raised or lowered field 4 can easily be located by touch and it is thus immediately clear on which side of the electronic key 1 the various actuating elements 3, 3′ and 3″ are located.

In contrast to the actuating elements 3, 3′ and 3″, the field 4 cannot be pressed in or actuated. It is generally possible to provide for the field 4 to bear an emblem 5, for example a trademark such as a Mercedes star or to be embodied as one. As a result, additional design advantages can be obtained and at the same time the corporate identity or the assignment of the electronic key 1 to a specific type of vehicle or to a specific make of vehicle can be facilitated. It is also conceivable, in contrast to the illustrations in FIGS. 1 and 2, not to highlight the entire field 4 but rather only a relief form of the emblem 5 arranged there. Furthermore it is conceivable for the emblem 5 to be visually highlighted with respect to the housing part 2. This may be done, for example, by means of a different color such as, for example, chrome. Generally, the field 4 can be embodied in any desired form, for example a circle (Mercedes star) or a triangle (Maybach emblem).

The slightly raised or countersunk field 4 is arranged in all the embodiment variants in such a way that it facilitates orientation on the surface 6 or in relation to the individual actuating elements 3, 3′ and 3″ and makes the electronic key 1 easier to handle.

To summarize, the essential features of the invention can be characterized as follows:

The invention provides an electronic key 1 for a locking system of a motor vehicle, which key 1 includes a plastic housing part 2 and at least two actuating elements 3, 3′ on the same side, respectively for one electrical switch. A field 4 is provided which cannot be actuated, is at least slightly raised or lowered in relation to the actuating elements 3, 3′ and forms a tactile separation between the at least two actuating elements 3, 3′ and thus makes the electronic key 1 easier to handle.

The slightly raised or lowered field 4 constitutes an orientation point on a surface 6 of the electronic key 1 and thus makes the individual actuating elements 3, 3′ significantly easier to locate on the surface 6 of the key.

Furthermore it is possible to provide for the field 4 to bear an emblem 5 or be embodied as one, and/or for this emblem 5 to be visually highlighted with respect to the housing part 2. This additionally provides the advantage of using the field 4 or the emblem 5 as a design element and thus enhancing the ability to assign the electronic key 1 to a specific type of vehicle or a specific make of vehicle.

1-7. (canceled)

8. An electronic key for a locking system of a motor vehicle, comprising a plastic housing which has at last two actuating elements on one side associated respectively with at least one electrical switch, the housing part including a field part which cannot be actuated and is at least slightly raised or lowered in relation to the actuation elements to thereby form a tactile separation between the at least two actuation elements.

9. The electronic key as claimed in claim 8, wherein the field part includes an emblem or is embodied as an emblem.

10. The electronic key as claimed in claim 9, wherein the emblem is visually highlighted with respect to the housing part.

11. The electronic key as claimed in claim 8, wherein each of the actuation elements and the field part which cannot be actuated are located on one side of the electronic key.

12. The electronic key as claimed in claim 8, wherein each of the at least two actuation elements are embodied as a button which can be deformed elastically for the purpose of actuation and extends into a surface of the housing part.

13. The electronic key as claimed in claim 8, wherein three actuation elements are provided, and the field part is arranged centrally in relation to the three actuation elements.

14. The electronic key as claimed in claim 8, wherein a side of the electronic key which faces away from the at least two actuation elements and from the field part is haptically neutral or smooth.

15. The electronic key as claimed in claim 9, wherein each of the actuation elements and the field part which cannot be actuated are located on one side of the electronic key.

16. The electronic key as claimed in claim 10, wherein each of the actuation elements and the field part which cannot be actuated are located on one side of the electronic key.

17. The electronic key as claimed in claim 9, wherein each of the at least two actuation elements are embodied as a button which can be deformed elastically for the purpose of actuation and extends into a surface of the housing part.

18. The electronic key as claimed in claim 10, wherein each of the at least two actuation elements are embodied as a button which can be deformed elastically for the purpose of actuation and extends into a surface of the housing part.

19. The electronic key as claimed in claim 11, wherein each of the at least two actuation elements are embodied as a button which can be deformed elastically for the purpose of actuation and extends into a surface of the housing part.

20. The electronic key as claimed in claim 9, wherein three actuation elements are provided, and the field part is arranged centrally in relation to the three actuation elements.

21. The electronic key as claimed in claim 10, wherein three actuation elements are provided, and the field part is arranged centrally in relation to the three actuation elements.

22. The electronic key as claimed in claim 11, wherein three actuation elements are provided, and the field part is arranged centrally in relation to the three actuation elements.

23. The electronic key as claimed in claim 12, wherein three actuation elements are provided, and the field part is arranged centrally in relation to the three actuation elements.

24. The electronic key as claimed in claim 9, wherein a side of the electronic key which faces away from the at least two actuation elements and from the field part is haptically neutral or smooth.

25. The electronic key as claimed in claim 10, wherein a side of the electronic key which faces away from the at least two actuation elements and from the field part is haptically neutral or smooth.

26. The electronic key as claimed in claim 11, wherein a side of the electronic key which faces away from the at least two actuation elements and from the field part is haptically neutral or smooth.

27. The electronic key as claimed in claim 12, wherein a side of the electronic key which faces away from the at least two actuation elements and from the field part is haptically neutral or smooth.
